(19) United States
(12) Patent Application Publication
(10) Pub. No.: US 2016/0110752 A1
(43) Pub. Date: Apr. 21, 2016

(54) METHODS, SYSTEMS, AND COMPUTER READABLE MEDIA FOR PROVIDING BENEFITS TO LOYALTY CARDHOLDERS VIA LOYALTY CARD TRANSACTIONS

(71) Applicant: MasterCard International Incorporated, Purchase, NY (US)

(72) Inventors: Stephen A. Parento, White Plains, NY (US); Sumeet Bhatt, Jericho, NY (US)

(21) Appl. No.: 14/520,265

(22) Filed: Oct. 21, 2014

(51) Int. Cl. G06Q 30/02

(52) U.S. Cl. CPC G06Q 30/0226

(57) ABSTRACT

Methods, systems, and computer readable media for providing benefits to loyalty cardholders via loyalty card transactions are disclosed. In one example, the method includes receiving, by a loyalty program module, a message indicating that a loyalty card transaction has been initiated at a participating merchant site using a loyalty card associated with a cardholder account, wherein the cardholder account is enrolled in a loyalty benefit program managed via the loyalty program module, determining a loyalty level assigned to the cardholder account using information regarding the loyalty card transaction contained in the message, and utilizing the loyalty level assigned to the cardholder account to determine at least one merchant-specific differentiated benefit to be provided to a holder of the loyalty card, wherein each loyalty level includes at least one merchant-specific differentiated benefit designated by the participating partner merchant.

### TECHNICAL FIELD

The subject matter described herein relates to card transactions and associated reward programs. More particularly, the subject matter described herein relates to systems, methods, and computer readable media for providing benefits to loyalty cardholders via loyalty card transactions.

### BACKGROUND

Currently, there are few, if any, loyalty card programs in the market that provide the cardholder with purchase-independent benefits. Notably, most loyalty card programs require a cardholder account to obtain a certain number of points, dollars, or other symbolic value, in order to receive a benefit or perk. The benefit or perk then, is generally a discount on a future purchase, such that these programs would be considered purchase-dependent loyalty programs. The object of these programs is to entice a cardholder into purchasing from the merchant site, then providing a discount at some future point. However, such purchase-dependent programs require the cardholder user to actually make enough purchase transactions to reach the point or dollar amount required in order to receive the perk or benefit. They must also make an additional purchase in order to take advantage of the perk where these future ‘discounts’ may not be something the cardholder most values when shopping at a particular merchant. In addition, the merchant may have other non-future purchase benefits they could provide that would also succeed in having a customer return to their business. Thus, such purchase-dependent loyalty card programs may not be the optimal program structure to engender good-will and incentivize cardholders to provide their patronage to participating merchants.

Accordingly, there exists a need for systems, methods, and computer readable media for providing benefits to loyalty cardholders via loyalty card transactions.

### SUMMARY

According to one aspect, the subject matter described herein relates to methods, systems, and computer readable media for providing benefits to loyalty cardholders via loyalty card transactions. In one embodiment, the method includes receiving a message, by a loyalty program module, indicating that a loyalty card transaction has been initiated at a participating merchant site using a loyalty card associated with a cardholder account, wherein the cardholder account is enrolled in a loyalty benefit program managed via the loyalty program module. The method further includes determining a loyalty level assigned to the cardholder account using information regarding the loyalty card transaction contained in the message. Additionally, the method includes utilizing the loyalty level assigned to the cardholder account to determine at least one merchant-specific differentiated benefit to be provided to a holder of the loyalty card, wherein each loyalty level comprises at least one merchant-specific differentiated benefit designated by the participating partner merchant.

In another embodiment, the system comprises at least one processor, memory, and a loyalty program module utilizing the at least one processor and the memory. The loyalty program module is configured to receive a message indicating that a loyalty card transaction has been initiated at a participating merchant site using a loyalty card associated with a cardholder account, wherein the cardholder account is enrolled in a loyalty benefit program managed via the loyalty program module. The loyalty program module is also configured to determine a loyalty level assigned to the cardholder account using information regarding the loyalty card transaction contained in the message, and is configured to utilize the loyalty level assigned to the cardholder account to determine at least one merchant-specific differentiated benefit to be provided to a holder of the loyalty card, wherein each loyalty level comprises at least one merchant-specific differentiated benefit designated by the participating partner merchant.

The subject matter described herein may be implemented in hardware, software, firmware, or any combination thereof. As such, the terms “function”, “node”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for providing benefits to loyalty cardholders via loyalty card transactions according to an embodiment of the subject matter described herein;

FIG. 2 is a flow chart illustrating an exemplary process for providing benefits to loyalty cardholders via loyalty card transactions according to an embodiment of the subject matter described herein; and

FIG. 3 is a high level block diagram of a general purpose computer system suitable for use in providing benefits to loyalty cardholders via loyalty card transactions according to an embodiment of the subject matter described herein.

### DETAILED DESCRIPTION

In accordance with the subject matter disclosed herein, methods, systems, and computer readable media for providing benefits to loyalty cardholders via loyalty card transactions are disclosed.

In some embodiments, the disclosed subject matter may be implemented via a program management server as a loyalty program module (LPM) that is aimed toward providing a loyalty benefit program that rewards prepaid cardholder users at participating merchant sites. Notably, in some embodiments, the loyalty program module may host and support a loyalty program website and a loyalty application.

An issuing entity of the prepaid card or another third party may be a manager (e.g. Perk Program Manager) of the loyalty benefit program. The manager of the loyalty benefit program may leverage the LPM to establish generic loyalty levels to be assigned to cardholder accounts and a set of guidelines for assigning individual loyalty levels to cardholder accounts. In some embodiments, for example, these guidelines may be in the form of a questionnaire or set of questions requesting information about the cardholder user. The information supplied by the cardholder user in response to the questions may be then used to determine which generic loyalty level should be assigned to the cardholder user. The different, generic loyalty levels may be synonymous with how desirous or important a cardholder user is as a prospective customer. For example, higher loyalty levels may be indicative of a highly desirable patron, while lower loyalty levels may be indicative of a less desirable patron. The program manager may also set parameters for how each individual loyalty level is to be assigned. In some embodiments, for example, this may include weighting each piece of information in view of what participating merchants may find important in potential customers.

In some embodiments, to obtain a loyalty level, a cardholder user may also leverage the LPM in order to supply the information requested by the loyalty program manager. The information supplied by the cardholder user may include demographic information such as, for example, age, income, marital status, amount of travel, etc., and account information such as, for example, cardholder user name, card number, etc. Once the cardholder user supplies the requested information, the cardholder account may be either automatically (for e.g. by an algorithm) or manually (for e.g. by a program manager) assigned a loyalty level based off of the information supplied. Different pieces of information supplied by the cardholder user may receive a different weight in assigning the loyalty level.

The program module may further be leveraged by participating merchants in order to designate and/or define merchant-specific differentiated benefits for each of the generic loyalty levels established by the program manager. Differentiated benefits may be considered as specialized perks or services provided by each partner merchant to participating cardholder users based on the participating users' individual loyalty levels assigned to their cardholder account. In keeping with the design of the loyalty benefit program, each partner merchant may define a specific benefit for each generic loyalty level, where the benefits may be scaled according to level. For example, higher loyalty levels may receive higher quality or more desirable perks than lower loyalty levels. Each participating partner merchant may leverage the LPM to list out the perks associated with each loyalty level of the loyalty benefit program. This list may be accessible to cardholder users. Thus cardholder users may access the list to determine participating merchants and their merchant-specific differentiated benefits. In some embodiments, the list may be filtered based on a current location of the cardholder user. This may be advantageous to traveling cardholder users who are unfamiliar with area merchants.

As a result, merchants who participate in the loyalty benefit program may incentivize participating cardholder users to visit their merchant site in order to receive such benefits independent of any purchase transactions by the participating cardholder user. Notably, the present subject matter effectively directs customer traffic to participating merchant sites at little to no cost to such businesses. Participating merchants are also incentivized, by the potential for increased foot traffic and revenue, to cross-promote the associated prepaid card product.

The LPM may additionally be leveraged by participating merchants when a loyalty card transaction is conducted at a participating merchant site. The loyalty benefit program is designed to provide benefits to cardholder users independent of any purchase transactions. Thus, a cardholder user may receive at least one benefit or perk as soon as they enter a participating merchant site. However, a cardholder user may choose to combine receiving a perk and conducting a purchase transaction. Therefore, in some embodiments, the LPM may be contacted by a reader device, or a point of sale (POS) device connected to the reader device at the merchant site, to request authorization and/or identification of the loyalty level associated with the cardholder account. Once the loyalty level associated with the cardholder account is identified and/or communicated back to the merchant (e.g., employee), the cardholder user may receive at least one merchant-specific differentiated benefit or perk associated with the loyalty level assigned to the cardholder's account. Although the present disclosure herein describes the conducting of a loyalty card transaction at a “merchant site,” the aforementioned transaction may be performed at any location associated with any type of provider of goods, products, and/or services (e.g., a hardware store, restaurant, a law firm, a dentist office, a movie cinema, a medical supply wholesaler, etc.) that is participating in the loyalty benefit program, without departing from the scope of the disclosed subject matter.

Notably, the program management server and its components and functionality described herein constitute a special purpose device that improves the technological field of prepaid card reward or benefit programs by providing i) a prepaid loyalty card reward program that encourages cardholder users to frequent merchant sites, ii) a loyalty program module that enables the participating merchants to customize the prepaid card reward or benefit program, and iii) at least one benefit or perk for one or more cardholder users (e.g., incentivized patronage of participating merchant sites) independent of purchase transaction.

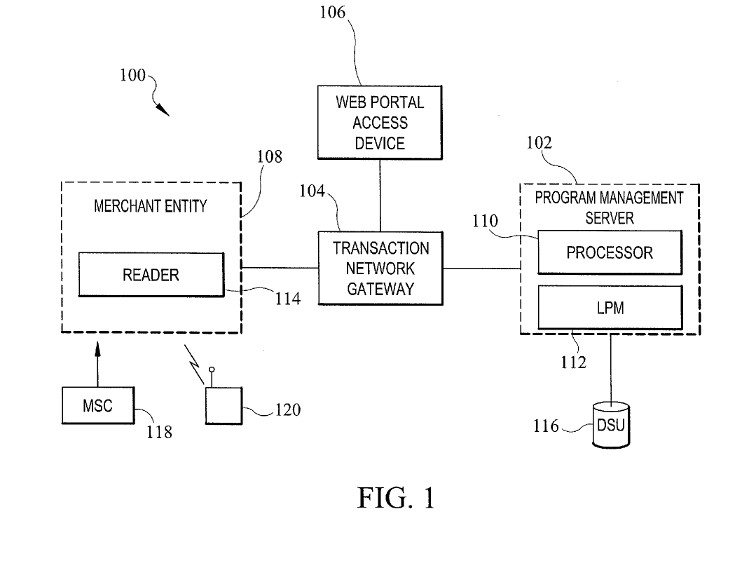

Although the following description discloses the use of a MasterCard network, other third party networks or entities may utilize the methods and systems disclosed herein without departing from the scope of the present subject matter. FIG. 1 depicts an exemplary loyalty card system 100 that includes a program management server 102, a transaction network gateway 104, a web portal access device 106, and at least one merchant entity 108. FIG. 1 further depicts participating merchant entity 108 comprising a reader device 114. Reader device 114 may include a magnetic stripe card reader or a smart card reader that may read data from a magnetic stripe card 118 that is swiped at reader device or from an EMV chip on the card when the smart card is dipped in a smart card reader 114, and/or a wireless device reader that is configured to wirelessly read data from smart cards and/or an NFC-enabled mobile device 120 brought in proximity to reader device 114. In some embodiments for example, reader device 114 may be in communication with a point of sale (POS) system (not shown). As illustrated in FIG. 1, each of components 102-106 may be embodied as a computer server and/or computer network node capable of electronic communications (e.g., via the Internet) with the other remaining components.

In some embodiments, program management server 102 may include any server, node, computer, or unit that is configured to i) establish, modify and/or update a number of loyalty levels in a loyalty benefit program, ii) process registrations of participating cardholder accounts made by cardholder users, iii) assign loyalty levels to participating cardholder accounts based off of information supplied by the cardholder users during registration, iv) process defined merchant-specific differentiated benefits for each loyalty level, v) communicate the loyalty level associated with a cardholder account when contacted by a merchant reader device, and vi) implement management and monitoring tasks using the methods described herein. Program management server 102 may include or implement a loyalty program module (LPM) 112, where LPM 112 may be used by both merchant entities and cardholder users to manage and monitor aspects of a loyalty benefit program. Although FIG. 1 depicts program management server 102 as a single network element, program management server 102 may include a plurality of network elements, a plurality of network components, and/or a network itself without departing from the scope of the present subject matter.

In some embodiments, program management server 102 may include at least one processor 110 and a loyalty program module (LPM) 112. LPM 112 may comprise separate modules, such as, a website support module and a loyalty application support module. In some embodiments, processor 110 may include a microprocessor, a central processing unit (CPU), or any other like hardware-based processor unit that is configured to execute and/or utilize LPM 112 (e.g., a software based algorithm) to communicate with a data storage unit 116, which may be configured to store loyalty benefit program data (i.e., established number of generic loyalty levels, cardholder account qualifications, merchant-specific differentiated benefits for each loyalty level, parameters, etc.). In some embodiments, LPM 112 may be stored in memory (not shown), such as random access memory (RAM), read only memory (ROM), optical read/write memory, cache memory, magnetic read/write memory, flash memory, or any other non-transitory storage media. In one embodiment, processor 110 and the aforementioned memory may be used to execute and manage the operation of LPM 112. In some embodiments, data storage unit 116 may include any storage medium that is configured to store prepaid cardholder account data and participating merchant data associated with the loyalty benefit program. Exemplary data storage units may include one or more external database servers accessible by program management server 102. Alternatively, data storage unit 116 may include a local database hosted by program management server 102. In some embodiments, data storage unit 116 may be provisioned with a plurality of profiles that include the specific parameters corresponding to the loyalty benefit programs operated by program management server 102.

In some embodiments, a representative (e.g., website administrator or program manager) associated with the prepaid card issuer entity (e.g. MasterCard) and/or another third party associated with the loyalty benefit program may access LPM 112 in order to manage and/or modify the loyalty benefit program. For example, the representative may establish the number of loyalty levels in the loyalty benefit program. In another example, the representative may update the parameters or qualifications needed for a cardholder account to be assigned to a certain loyalty level.

In some aspects, LPM 112 may support a configuration webpage associated with the loyalty benefit program. For example, the configuration webpage may be utilized by an issuer entity or another associated third party to configure and manage the loyalty benefit program. Specifically, the configuration webpage may comprise a plurality of different user interface (UI) elements that enable a user, such as a program manager (e.g. Perk Program Manager), to configure the specific parameters and characteristics of the loyalty benefit program. For example, the configuration webpage may comprise the functionality to allow a program manager to establish generic loyalty levels associated with the loyalty benefit program. The number of generic loyalty levels established by the administrator may be dependent on a variety of factors, which may include, for example, the ease of management. In some embodiments, between three and seven generic loyalty levels may be established.

In another example, the configuration webpage may comprise the functionality to allow a program manager to establish guidelines and/or parameters for assigning individual loyalty levels to cardholder accounts. In some embodiments, the parameters may be in the form of a set questions requesting information about the cardholder user to be supplied by the cardholder user. Such information may include, for example, demographic information and/or cardholder account information. In some aspects, demographic information may comprise information that an issuing entity believes merchants may find relevant and valuable, such as, for example, age, sex, income, marital status, frequency of travel, etc. Cardholder account information may comprise information associated with the cardholder account, such as, for example, name, card number, etc. In some embodiments, some of the information requested by the issuing entity may not be used in assigning the cardholder account a loyalty level. This information may just be used for advertising purposes, research purposes, etc., and may just be optional for the cardholder to input. However, some of the information requested may be necessary in determining the loyalty level associated with the cardholder account.

Returning to FIG. 1, a web portal access device 106 may be utilized by a cardholder user to enroll in and manage a loyalty benefit program account (e.g., an account established and/or configured above via an associated web portal) hosted by program management server 102. In some embodiments, web portal access device 106 may also comprise any computing device (e.g., a personal computer, a mobile smartphone device, a tablet computer, etc.) that is provisioned with an application (e.g., a web browser application or mobile phone app) that may establish communication with and access LPM 112. For example, web portal access device 106 may be utilized by a cardholder user to access a prepaid cardholder account associated with the loyalty benefit program in order to enroll in the program. LPM 112 may provide and support content associated with the loyalty benefit program. For example, LPM 112 may support a web portal associated with the loyalty benefit program. The web portal may comprise a plurality of UI elements that enable a cardholder user to enter information required for enrollment in the loyalty benefit program. The information required may be established by an issuing entity or another third party associated with the loyalty benefit program.

The LPM 112 may be configured to enable the issuing entity or another third party entity to assign a loyalty level to the participating cardholder account based off of the information supplied by the cardholder user. In some embodiments, once a cardholder user successfully inputs the required information, the issuing entity may utilize the LPM 112 to assign a loyalty level to the cardholder account from the established generic loyalty levels. Determining the loyalty level to be assigned to the cardholder account may be based on an algorithm, or other formula, designed by the issuing entity, and/or it may be manually done. Where the loyalty level is determined based on an algorithm determined by the issuing entity, the loyalty level may be automatically assigned to the cardholder account once all the required information has been input, for e.g., on the web portal by the cardholder user. The algorithm may weight different information input by the cardholder user at different values and output a loyalty level assigned to the cardholder account based on these weighted values. Alternatively, a program manager may manually assign a loyalty level to a cardholder account. For example, the program manager may consider the information input by the cardholder user and make a determination of the loyalty level appropriate for that cardholder account (e.g. a subjective determination, an objective determination, or a combination of both). For example, cardholder users with higher incomes and frequent travel may be assigned a higher loyalty level than cardholder users with lower incomes and less frequent travel.

LPM 112 may also be configured to enable cardholder users to monitor and manage their cardholder account. For example, an associated web portal, accessible for e.g., by web portal access device 106, may enable a cardholder user to perform tasks such as viewing the assigned loyalty level, managing cardholder information, etc. In some embodiments, the loyalty level may be updated based on changes in the cardholder user's demographic information (e.g. income increase, change in marital status, increase in traveling, etc.). In one embodiment, this may be accomplished via the cardholder user requesting to the issuing entity a change to the loyalty level or may be automatically done when the cardholder updates cardholder information.

In some embodiments, interested merchants may be able to enroll in the loyalty benefit program. Merchants interested in becoming a participating or a partner merchant in the program may first need to define or designate differentiated services or benefits to be offered at a defined merchant site for each generic loyalty level established by the issuing entity or other third party. With regard to the subject matter of this application, differentiated benefits means separate and distinct perks or services. The differentiated benefits may include services or perks to be delivered to the cardholder user at the merchant site, independent of any purchase transaction. The differentiated services or benefits associated with each generic loyalty level may be scaled accordingly, whereby higher tier loyalty levels may equate to more desirable perks than lower tier loyalty levels. For example, where the partner merchant is a spa or other type of salon merchant, the spa merchant may offer cardholder users whose accounts are associated with the highest loyalty level the benefit of a complimentary facial, while the spa merchant may offer cardholder users whose accounts are associated with the lowest loyalty level the benefit of a complimentary eyebrow wax. In some embodiments, the different loyalty levels may also receive a different quantity of perks, where higher loyalty levels may receive several perks or services and lower loyalty levels may receive fewer. For example, where the partner merchant is a mechanic, the mechanic may offer a complimentary tire rotation and a complimentary exterior car detail to cardholder users whose accounts are associated with the highest loyalty level, while the mechanic may offer only a complimentary car wash to cardholder users whose accounts are associated with the lowest loyalty level. The perks to be delivered by the participating partner merchant may also depend on the services, goods, etc. offered by the partner merchant. For example, where the partner merchant is a restaurant, the perk offered to cardholder users whose accounts are associated with the highest loyalty level may be a complimentary bottle of expensive champagne, while the perk offered to cardholder users whose accounts are associated with the lowest loyalty level may be a complimentary dessert. In comparison, a spa or salon partner merchant may provide the benefits described above. One of ordinary skill in the art will understand that intermediate loyalty levels may receive benefits that are appropriately scaled between the highest and the lowest loyalty levels. For example, where the partner merchant is the above-described restaurant, the perk offered to cardholder users whose accounts are associated with an intermediate loyalty level (i.e. a loyalty level that is not the highest and not the lowest loyalty level) may receive a complimentary bottle of less expensive champagne. Thus, each generic loyalty level may have an appropriately scaled, differentiated perk to be defined by each partner merchant.

In some embodiments, the issuing entity or other third party may require the interested merchants to submit to a verification process, for e.g., a phone call, a merchant site visit, etc. by an administrator of the issuing entity. The verification process may be implemented in order to determine that each interested merchant has defined a merchant-specific differentiated perk or benefit for each generic loyalty level. In some aspects, this may include the issuing entity approving the benefit(s) defined for each loyalty level. Once the interested merchant has been approved by the issuing entity, the merchant may be designated a participating partner merchant.

LPM 112 may be configured to display all participating partner merchants. For example, LPM 112 may be configured to provide a listing of all participating partner merchants and their merchant-specific different benefits for each of the loyalty levels on a web portal or other website associated with the loyalty benefit program. Such information may be accessible using a web portal access device 106 or other similar type of device, where web portal access device 106 may include an application or “app” for accessing a listing of all participating partner merchants from LPM 112. For example, the application may be a loyalty application downloaded from an application store onto web portal access device 106. The loyalty application may comprise a plurality of user interface (UI) elements that enable a user, such as a cardholder user, to filter the listing in terms of type of merchant, merchant rating, etc. The loyalty application may also be configured to list participating merchants within a certain distance to the user of web portal access device 106. For example, web portal access device 106 may include a global positioning system (GPS) and/or other location service that may interface with the program management server 102 to display only those participating merchants within a geographic region, for example a ten mile radius. One of the UI elements of the loyalty application may enable the user of web portal access device 106 to modify the geographic region to be one of a range of regions.

Returning to FIG. 1, after utilizing web portal access device 106 to enroll in the loyalty benefit program, a cardholder user may access the web portal to determine participating partner merchants. Thus, a cardholder user may identify a participating merchant in order to visit their merchant site and conduct a loyalty transaction. As used herein, a loyalty transaction may include a loyalty card identification system associated with a loyalty benefit program that is concerned with identifying both a cardholder user and a loyalty level associated with a cardholder account enrolled in the loyalty benefit program, and delivering at least one differentiated merchant-specific benefit to the cardholder user based on the loyalty level associated with the cardholder account of the cardholder user, where the delivery of the differentiated merchant-specific perk may be purchase independent.

In some embodiments, a cardholder user may initiate a loyalty card or loyalty transaction at a reader device 114 at a merchant site location, such as a brick and mortar merchant store. Exemplary reader devices may include a magnetic stripe reader, a wireless smartcard reader, a wireless device reader, and the like. For example, reader device 114 in FIG. 1 may include a magnetic stripe card reader that is configured to read a magnetic stripe card (MSC) 118 (e.g., a prepaid loyalty card associated with the cardholder account) that is swiped by the cardholder user. In some embodiments, the prepaid loyalty card associated with the cardholder account may not be a physical card. For example, reader device 114 may also or alternatively comprise a wireless device reader that is configured to wirelessly communicate with a cardholder user's near field communications (NFC) enabled smartcard or mobile device 120 in order to wirelessly receive loyalty card information (e.g., loyalty card number or a proxy number) to initiate a loyalty transaction at reader 114 (e.g., wirelessly receiving loyalty card data associated with a loyalty card “softcard” application provisioned on the smart card or mobile device). For example, mobile device 120 may be configured to communicate loyalty card data with a wireless device reader 114 via near field communications (NFC) to initiate the purchase transaction. In some embodiments, since the loyalty transaction may be independent of a purchase transaction, reader device 114 may or may not be in communication with a point of service (POS) device or system (not shown), where the POS device may include any type of device or unit that is configured to facilitate a payment card transaction. Exemplary POS devices may include self-service kiosks, self-checkout units, point of sale cashier terminals/registers, and the like.

Upon presenting and/or interfacing the loyalty card (e.g., a magnetic strip card 118 or an electronic loyalty card provisioned on mobile device 120) with reader device 114, reader 114 may obtain loyalty card credentials and related data from the loyalty card and subsequently generate loyalty transaction data. Exemplary loyalty transaction data may include, but is not limited to, i) a cardholder account number (e.g., a primary account number or PAN), ii) a card number, and iii) a card proxy number. The loyalty transaction data may then be sent from reader 114 to program management server 102 as a loyalty card authorization request message via transaction network gateway 104. Although not shown in FIG. 1, the loyalty card authorization request message may also traverse other network elements, such as an acquirer entity server or network routing server, prior to reaching the transaction network gateway 104 or program management server 102. In some embodiments, transaction network gateway 104 may include any gateway server, node, or unit that serves as an entry and exit point for communications (e.g., packet traffic) entering and leaving a loyalty transaction network and associated infrastructure (e.g., MasterCard network infrastructure or “MasterCard network”). Transaction network gateway 104 may be communicatively connected to program management server 102, which may also be located within the loyalty transaction network.

Upon receiving the loyalty card authorization request, transaction network gateway 104 may be configured to perform a plurality of functions. For example, transaction network gateway 104 may be configured to forward the loyalty card authorization request message containing the loyalty transaction data to program management server 102. As an alternative to forwarding the loyalty card authorization request message, transaction network gateway 104 may instead be configured to extract the loyalty transaction data from the loyalty card authorization request message received from merchant entity 108 and subsequently generate a loyalty indication message that includes the extracted loyalty transaction data. Afterwards, transaction network gateway 104 may send loyalty indication message containing the loyalty transaction data to program management server 102. In some embodiments, each of the loyalty card authorization request message and the loyalty indication message may comprise a web based message, such as an XML request message. However, each of the loyalty card authorization request message and the loyalty indication message may be generated in any web based protocol, format, or specification in alternative embodiments without departing from the scope of the present subject matter.

Regardless of the manner in which the loyalty transaction data is received (e.g., loyalty card authorization request message or loyalty indication message) program management server 102 may be configured to utilize the loyalty transaction data to determine the generic loyalty level associated with the cardholder account. In some embodiments, program management server 102 utilizes the cardholder account information (e.g. card number or a proxy number) contained in the received loyalty indication message or loyalty card authorization request message to determine the loyalty level associated with that cardholder account via the card number. For example, program management server 102 may identify the loyalty level assigned to the cardholder account by the issuer entity or other third party based on the received card number and/or the cardholder name. In some embodiments, the card numbers (or proxy numbers) associated with the cardholder account and the corresponding loyalty level are securely stored in data storage unit 116.

The program management server 102 may then communicate back to reader 114, traversing transaction network gateway 104 in a manner similar to the one described above, the loyalty level associated with the cardholder account. The at least one merchant-specific differentiated perk or benefit that corresponds to the loyalty level of that cardholder user may then be delivered to the cardholder user by a representative (e.g. employee) of the participating merchant.

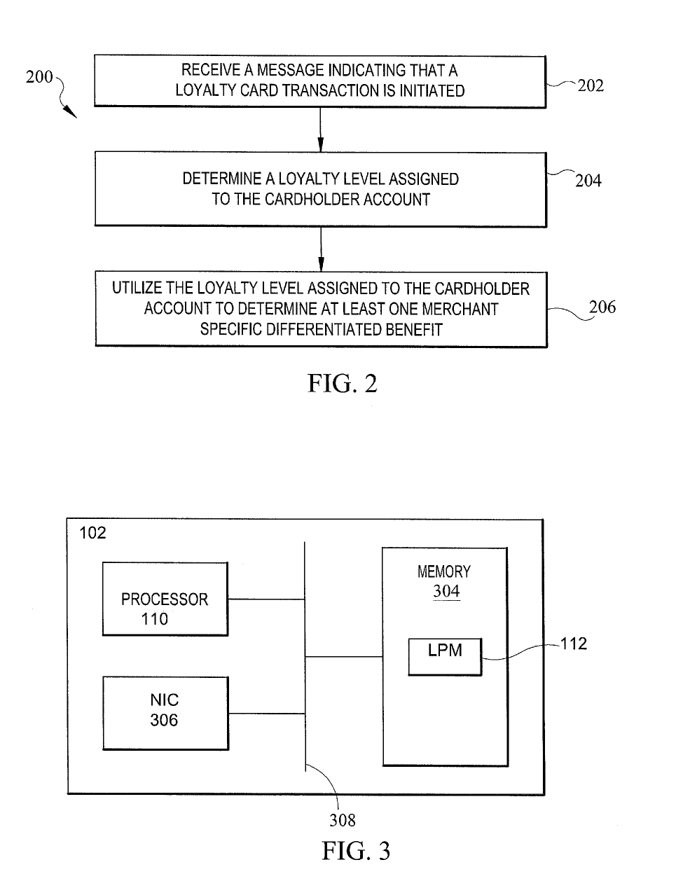

FIG. 2 depicts a flow chart illustrating an exemplary method 200 for loyalty cardholders via loyalty card transactions according to an embodiment of the subject matter described herein. In step 202, a loyalty card transaction is conducted with a loyalty card. In some embodiments, a cardholder user may utilize the loyalty card at a participating merchant site (e.g., a brick and mortar merchant store). The loyalty card transaction may be independent of any type of purchase transaction. For example, the loyalty card may be presented and utilized at a reader 114, either via the swiping of magnetic swipe card (MSC) 118 at a magnetic card stripe reader 114, which may or may not be connected to a point of sale (POS) device (not shown) or via NFC conducted between a wireless device reader 114 and an NFC enabled mobile device 120 (or smart card) to initiate the loyalty transaction.

At that point, a transaction indication message may be received at a program management server 102. In some embodiments, loyalty transaction data associated with the conducted loyalty transaction may be sent from merchant entity 108 to program management server 102 via transaction network gateway 104. In some embodiments, merchant entity 108 may generate and send a loyalty card authorization request message that includes information regarding the loyalty card transaction, which includes details corresponding to the loyalty transaction initiated by the cardholder user at the merchant store site. Upon receipt of the message, transaction network gateway 104 may forward the loyalty card authorization request message containing the loyalty transaction data to program management server 102. In some alternate embodiments, transaction network gateway 104 may be configured to i) extract loyalty card transaction information from the received loyalty card authorization request message, ii) generate a loyalty indication message that includes the extracted loyalty transaction data, and iii) send the generated loyalty indication message to program management server 102. Exemplary loyalty transaction information included in the payment card authorization request message and/or the purchase indication message includes, but is not limited to a cardholder account number, card number and/or proxy number.

At step 204, loyalty card transaction information is extracted and processed to determine a loyalty level assigned to the cardholder account. In some embodiments, program management server 102 may be configured (e.g., via execution of LPM 112 by processor 110) to extract loyalty card transaction information from the received loyalty card authorization request message (or the loyalty indication message). In some embodiments, program management server 102 may extract a cardholder account number, card number and/or proxy number. In some embodiments, program management server 102 may be configured to utilize the extracted cardholder account number, card number, and/or proxy number to access a cardholder's account, which specifies the loyalty level assigned to the cardholder account.

In step 206, the loyalty level assigned to the cardholder's account is utilized to determine at least one merchant-specific differentiated benefit to be provided to a holder of the loyalty card (e.g. cardholder user) in the event the loyalty card transaction is initiated at a participating merchant site. In some embodiments, program management server 102 may be configured to communicate the extracted loyalty level from the received loyalty card transaction information (e.g., obtained in step 204) in response to determining the loyalty level assigned to the cardholder account. The extracted loyalty level may be communicated through transaction network gateway 104 to a reader device 114 back at merchant site 108. Once the extracted loyalty level assigned to the cardholder account is provided to reader device 114 or any other device, such as, e.g. POS device (not shown), an employee or other associate of the participating partner merchant may determine the corresponding benefit to provide to the cardholder user. The at least one merchant-specific differentiated benefit may be the benefit designated by the participating partner merchant, where each generic loyalty level established by the issuing entity may have at least one correspondingly scaled and differentiated merchant-specific benefit. Therefore, the merchant-specific differentiated benefit provided to the cardholder user may be based upon the loyalty level associated with that cardholder's cardholder account. For example, if a cardholder user enters a merchant site and initiates a loyalty card transaction, an employee of the participating partner merchant may determine the loyalty level assigned to the cardholder user's account, using the process as indicated above. The employee may then provide to the cardholder user the at least one differentiated merchant-specific benefit corresponding to the cardholder user's assigned loyalty level.

FIG. 3 depicts a high level block diagram of exemplary components of program management server 102 suitable for use in performing the functions described herein. As depicted in FIG. 3, server 102 comprises a processor 110, a memory 304, and a network interface card (NIC) 306 communicatively connected via a system bus 308. In some embodiments, processor 110 can comprise can comprise a microprocessor, central processing unit (CPU), or any other like hardware based processing unit. In some embodiments, a loyalty program module (LPM) 112 can be stored in memory 304, which can comprise random access memory (RAM), read only memory (ROM), optical read/write memory, cache memory, magnetic read/write memory, flash memory, or any other non-transitory computer readable medium. In some embodiments, processor 110 and memory 304 can be used to execute and manage the operation of LPM 112. NIC 306 may be an Ethernet card or other I/O interface card that allows server 102 to communicate with other devices over a computer network. Thus, when configured with LPM 112, as described herein, server 102 becomes a special purpose computing platform that improves the technological area of distributing loyalty-level-differentiated perks to loyalty program members over a computer network.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for providing benefits to loyalty cardholders via loyalty card transactions, the method comprising:
receiving, by a loyalty program module, a message indicating that a loyalty card transaction has been initiated at a participating merchant site using a loyalty card associated with a cardholder account, wherein the cardholder account is enrolled in a loyalty benefit program managed via the loyalty program module;
determining a loyalty level assigned to the cardholder account using information regarding the loyalty card transaction contained in the message; and
utilizing the loyalty level assigned to the cardholder account to determine at least one merchant-specific differentiated benefit to be provided to a holder of the loyalty card, wherein each loyalty level comprises at least one merchant-specific differentiated benefit designated by the participating partner merchant.

2. The method of claim 1, further comprising: receiving, by the loyalty program module, cardholder user information associated with the cardholder account.

3. The method of claim 2, wherein the cardholder user information comprises demographic information, such as at least one of age, income, marital status, and other relevant demographic information; loyalty card number; and name of the cardholder user.

4. The method of claim 2, wherein the loyalty level is assigned to the cardholder account by the loyalty program module based on the cardholder user information.

5. The method of claim 4, wherein the loyalty program module stores one or more of the cardholder user information associated with the cardholder account, the loyalty level assigned to the cardholder account, a listing of the participating partner merchants, and the merchant-specific differentiated benefit for each of the loyalty levels.

6. The method of claim 1, wherein a listing of the participating partner merchants and their merchant-specific differentiated benefits for each of the loyalty levels is accessible via the loyalty program module.

7. The method of claim 1, wherein each participating partner merchant utilizes the loyalty program module to designate the at least one merchant-specific differentiated benefit for each of the loyalty levels.

8. The method of claim 1, wherein the message includes either a loyalty card transaction indication message or a loyalty card authorization request message.

9. A system for providing benefits to loyalty cardholders via loyalty card transactions, the system comprising:
at least one processor;
memory; and
a loyalty program module utilizing the at least one processor and the memory, wherein the loyalty program module is configured to:
receive a message indicating that a loyalty card transaction has been initiated at a participating merchant site using a loyalty card associated with a cardholder account, wherein the cardholder account is enrolled in a loyalty benefit program managed via the loyalty program module;
determine a loyalty level assigned to the cardholder account using information regarding the loyalty card transaction contained in the message; and
utilize the loyalty level assigned to the cardholder account to determine at least one merchant-specific differentiated benefit to be provided to a holder of the loyalty card, wherein each loyalty level comprises at least one merchant-specific differentiated benefit designated by the participating partner merchant.

10. The system of claim 9, wherein the loyalty program module is configured to receive cardholder user information associated with the cardholder account.

11. The system of claim 10, wherein the cardholder user information comprises demographic information, such as at least one of age, income, marital status, and other relevant demographic information; loyalty card number; and name of the cardholder user.

12. The system of claim 10, wherein the loyalty program module is configured to assign the loyalty level to the cardholder account based on the cardholder user information.

13. The system of claim 12, wherein the loyalty program module is configured to store one or more of the cardholder user information associated with the cardholder account, the loyalty level assigned to the cardholder account, a listing of the participating partner merchants, and the merchant-specific differentiated benefit for each of the loyalty levels

14. The system of claim 9, wherein the loyalty program module is configured to provide a listing of the participating partner merchants and their merchant-specific differentiated benefits for each of the loyalty levels that is accessible to cardholder users.

15. The system of claim 9, wherein each participating partner merchant utilizes the loyalty program module to designate the at least one merchant-specific differentiated benefit for each of the loyalty levels.

16. The system of claim 9, wherein the message includes either a loyalty card transaction indication message or a loyalty card authorization request message.

17. A non-transitory computer readable medium having stored thereon executable instructions for controlling a computer to perform steps comprising:
receiving, by a loyalty program module, a message indicating that a loyalty card transaction has been initiated at a participating merchant site using a loyalty card associated with a cardholder account, wherein the cardholder account is enrolled in a loyalty benefit program managed via the loyalty program module;
determining a loyalty level assigned to the cardholder account using information regarding the loyalty card transaction contained in the message; and
utilizing the loyalty level assigned to the cardholder account to determine at least one merchant-specific differentiated benefit to be provided to a holder of the loyalty card, wherein each loyalty level comprises at least one merchant-specific differentiated benefit designated by the participating partner merchant.

18. The non-transitory computer readable medium of claim 17, further comprising receiving, by the loyalty program module, cardholder user information associated with the cardholder account; and assigning to the cardholder account the loyalty level based on the cardholder user information.

19. The non-transitory computer readable medium of claim 18, wherein the loyalty program module stores one or more of the cardholder user information associated with the cardholder account, the loyalty level assigned to the cardholder account, a listing of the participating partner merchants, and the merchant-specific differentiated benefit for each of the loyalty levels.

20. The non-transitory computer readable medium of claim 17, wherein each participating partner merchant utilizes the loyalty program module to designate the merchant-specific differentiated benefit for each of the loyalty levels.
